(19) United States
(12) Patent Application Publication
(10) Pub. No.: US 2024/0405694 A1
(43) Pub. Date: Dec. 5, 2024

(54) POWER CONVERTING APPARATUS, MOTOR DRIVE UNIT, AND REFRIGERATION CYCLE-INCORPORATING DEVICE

(71) Applicant: Mitsubishi Electric Corporation, Tokyo (JP)

(72) Inventors: Koichi ARISAWA, Tokyo (JP); Kengo KAWAUCHI, Tokyo (JP); Takaaki TAKAHARA, Tokyo (JP); Tomohiro KUTSUKI, Tokyo (JP); Haruka MATSUO, Tokyo (JP)

(21) Appl. No.: 18/698,117

(22) PCT Filed: Dec. 6, 2021
(86) PCT No.: PCT/JP2021/044712

§ 371 Date: Apr. 3, 2024

(51) Int. Cl. H02M 7/48; H02M 1/00; H02M 7/04; H02P 21/18; H02P 21/20; H02P 27/06

(52) U.S. Cl. CPC H02M 7/48; H02M 1/0009; H02M 7/05; H02P 21/18; H02P 21/20; H02P 27/06

(57) ABSTRACT

A power converting apparatus includes a rectifier unit that rectifies a supply voltage applied from a commercial power supply, a capacitor connected to an output end of the rectifier unit, an inverter that converts direct-current power output from the capacitor into alternating-current power and outputs the alternating-current power to a device including a motor, current detection units that detect a power state of the capacitor, and a control unit that performs, by controlling the inverter, load pulsation compensation and power-supply pulsation compensation and adjusts a degree of at least one of the load pulsation compensation and the power-supply pulsation compensation on a basis of detection values of the current detection units. The load pulsation compensation is performed to compensate a load pulsation in a load unit including the inverter and the device. The power-supply pulsation compensation is performed to compensate a power-supply pulsation in the load unit.

### CROSS REFERENCE TO RELATED APPLICATION

This application is a U.S. national stage application of PCT/JP2021/044712 filed on Dec. 6, 2021, the contents of which are incorporated herein by reference.

### FIELD

The present disclosure relates to a power converting apparatus that converts alternating-current (AC) power into desired power, and to a motor drive unit and a refrigeration cycle-incorporating device.

### BACKGROUND

A power converting apparatus has conventionally been known that converts AC power supplied from an AC power supply into desired AC power, and supplies the desired AC power to a load such as an air conditioner. For example, Patent Literature 1 given below discloses a technology in which a power converting apparatus, serving as a control device of an air conditioner, rectifies AC power supplied from an AC power supply by a diode stack serving as a rectifier unit, converts power that has been obtained by further smoothing by a smoothing capacitor, into desired AC power in an inverter consisting of multiple switching elements, and outputs the desired AC power to a compressor motor, which is a load.

### PATENT LITERATURE

Patent Literature 1: Japanese Patent Application Laid-open No. H7-71805

However, the foregoing conventional technology causes a high current to flow to the smoothing capacitor, thereby presenting a problem in acceleration of aging degradation of the smoothing capacitor. A conceivable method to address such problem is to use a higher capacity smoothing capacitor to reduce ripple fluctuation in the capacitor voltage, or to use a smoothing capacitor having high resistance to degradation caused by ripples. However, this then presents issues of high costs of capacitor components and a larger size of the apparatus.

In addition, the issue of aging degradation of the smoothing capacitor may be addressed by controlling an operation of the inverter to cause a pulsation dependent on a detection value of the capacitor voltage to be superimposed on the motor driving pattern. However, use of merely this control causes an increase in the root-mean-square values of the motor current and of the inverter current flowing through the inverter, thereby causing an increase in losses in the semiconductor devices and in the motor windings. This presents an issue of decrease in efficiency of the apparatus.

### SUMMARY

The present disclosure has been made in view of the foregoing, and it is an object of the present disclosure to provide a power converting apparatus capable of avoiding an increase in the size of the apparatus, and moreover, capable of operating the apparatus with high efficiency while reducing degradation of the capacitor for smoothing.

To solve the problem and achieve the object described above, a power converting apparatus according to the present disclosure includes a rectifier unit, a capacitor connected to an output end of the rectifier unit, an inverter connected across the capacitor, a detection unit that detects a power state of the capacitor, and a control unit. The rectifier unit rectifies a supply voltage applied from an alternating-current power supply. The inverter converts direct-current power output from the capacitor into alternating-current power, and outputs the alternating-current power to a device including a motor. The control unit performs, by controlling the inverter, load pulsation compensation for compensating a load pulsation in a load unit, and power-supply pulsation compensation for compensating a power-supply pulsation in the load unit, and adjusts a degree of at least one of the load pulsation compensation and the power-supply pulsation compensation on the basis of a detection value of the detection unit, where the load unit includes the inverter and the device.

A power converting apparatus according to the present disclosure provides an advantage in capability of avoiding an increase in the size of the apparatus, and moreover, capability of operating the apparatus with high efficiency while reducing degradation of the capacitor for smoothing.

### BRIEF DESCRIPTION OF DRAWINGS

FIG. 1 is a diagram illustrating an example configuration of a power converting apparatus according to a first embodiment.

FIG. 2 is a block diagram illustrating the power converting apparatus according to the first embodiment, focusing the functionality thereof.

FIG. 3 is a block diagram illustrating an example configuration of a control unit included in the power converting apparatus according to the first embodiment.

FIG. 4 is a diagram for describing example settings of a first adjustment factor for use in a current-adjusting calculation unit according to the first embodiment.

FIG. 5 is a diagram for describing example settings of a second adjustment factor for use in the current-adjusting calculation unit according to the first embodiment.

FIG. 6 is a diagram for describing an example setting of the first adjustment factor with respect to the mechanical angular frequency for use in the current-adjusting calculation unit according to the first embodiment.

FIG. 7 is a diagram for describing an example setting of the second adjustment factor with respect to a second current for use in the current-adjusting calculation unit according to the first embodiment.

FIG. 8 is a block diagram illustrating an example of hardware configuration for implementing the functionality of the control unit according to the first embodiment.

FIG. 9 is a block diagram illustrating another example of hardware configuration for implementing the functionality of the control unit according to the first embodiment.

FIG. 10 is a diagram illustrating an example configuration of a refrigeration cycle-incorporating device according to a second embodiment.

### DETAILED DESCRIPTION

A power converting apparatus, a motor drive unit, and a refrigeration cycle-incorporating device according to embodiments of the present disclosure will be described in detail below with reference to the accompanying drawings.

### First Embodiment

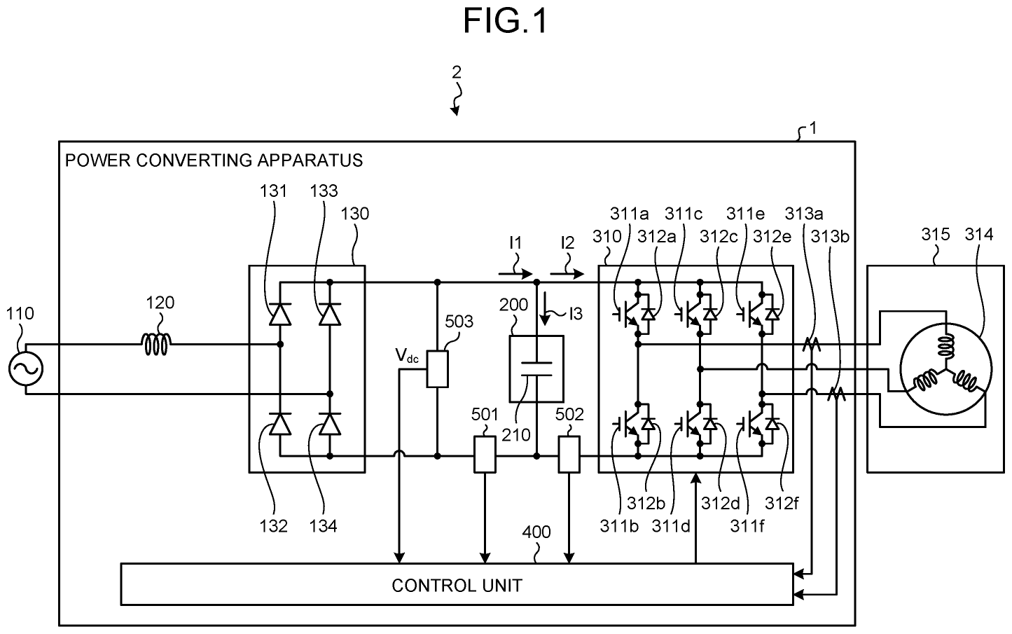

FIG. 1 is a diagram illustrating an example configuration of a power converting apparatus 1 according to a first embodiment. In FIG. 1, the power converting apparatus 1 is connected to a commercial power supply 110 and to a compressor 315. The commercial power supply 110 is an example of alternating-current (AC) power supply. The compressor 315 is an example of device referred to as such in the first embodiment. The compressor 315 includes a motor 314. The power converting apparatus 1 and the motor 314 included in the compressor 315 together form a motor drive unit 2.

The power converting apparatus 1 includes a reactor 120, a rectifier unit 130, current detection units 501 and 502, a voltage detection unit 503, a smoothing unit 200, an inverter 310, current detection units 313a and 313b, and a control unit 400.

The reactor 120 is connected between the commercial power supply 110 and the rectifier unit 130. The rectifier unit 130 includes a bridge circuit including rectifier elements 131 to 134. The rectifier unit 130 rectifies a supply voltage applied from the commercial power supply 110, and outputs a resulting voltage. The rectifier unit 130 performs full-wave rectification.

The smoothing unit 200 is connected to output ends of the rectifier unit 130. The smoothing unit 200 includes a capacitor 210 as a smoothing element to smooth the rectified voltage output from the rectifier unit 130. The capacitor 210 is, for example, an electrolytic capacitor, a film capacitor, or the like. The capacitor 210 is connected to the output ends of the rectifier unit 130. The capacitor 210 has a capacity dependent on the degree of smoothing to be performed on the rectified voltage. This smoothing causes the voltage generated across the capacitor 210 to have a waveform shape including a voltage ripple dependent on the frequency of the commercial power supply 110 superimposed on the direct-current (DC) component, rather than a waveform shape obtained by full-wave rectification of the rectified voltage. Thus, the voltage generated across the capacitor 210 does not pulsate largely. The frequency of this voltage ripple is a frequency component twice the frequency of the supply voltage when the commercial power supply 110 is a single-phase power supply, and has a primary component that is a frequency component six times the frequency of the supply voltage when the commercial power supply 110 is a three-phase power supply. When the power input from the commercial power supply 110 and the power output from the inverter 310 do not vary, the amplitude of this voltage ripple depends on the capacitance of the capacitor 210. However, to prevent high cost of the capacitor 210, the power converting apparatus 1 according to the present disclosure is designed not to have a high capacitance. This causes the capacitor 210 to be subjected to a certain magnitude of voltage ripple. For example, the capacitor 210 has a voltage that pulsates within a range in which the maximum value of the voltage ripple is less than twice the minimum value thereof.

The current detection unit 501 detects a first current I1, which is a current flowing from the rectifier unit 130, and outputs the detection value of the first current I1 detected, to the control unit 400. The current detection unit 502 detects a second current I2, which is a current flowing into the inverter 310, and outputs the detection value of the second current I2 detected, to the control unit 400. The voltage detection unit 503 detects a DC bus voltage V_{dc}, which is the voltage across the capacitor 210, and outputs the detection value of the DC bus voltage V_{dc} detected, to the control unit 400. Any of the current detection units 501 and 502 and the voltage detection unit 503 can be used as a detection unit for detecting a power state of the capacitor 210.

The inverter 310 is connected across the smoothing unit 200, i.e., across the capacitor 210. The inverter 310 includes switching elements 311a to 311f and freewheeling diodes 312a to 312f. The inverter 310 turns on and off the switching elements 311a to 311f under control of the control unit 400 to convert power that is output from the rectifier unit 130 and from the smoothing unit 200 into AC power having a desired amplitude and a desired phase, and outputs the AC power to the compressor 315, which is a device including the motor 314.

The current detection units 313a and 313b each detect a current value of a corresponding one of the motor currents of three phases output from the inverter 310 to the motor 314. The detection values of the current detection units 313a and 313b are input to the control unit 400. Based on the detection values of currents of two of the phases detected by the current detection units 313a and 313b, the control unit 400 obtains the value of the current of the remaining one phase by calculation. Note that the present example provides a method in which values of currents flowing to the motor 314 are obtained to reproduce the three-phase current, but the method is not limited thereto. The three-phase current may be reproduced by obtaining the value of the current flowing between the capacitor 210 of the smoothing unit 200 and the inverter 310, or by using another similar method.

The motor 314 included in the compressor 315 rotates according to the amplitude and the phase of the AC power supplied from the inverter 310 to perform compression operation. When the compressor 315 is a hermetic compressor for use in an apparatus such as an air conditioner, the load torque of the compressor 315 can often be regarded as a constant torque load.

Note that FIG. 1 illustrates a case in which the motor 314 has motor windings of Y connection, but the motor winding configuration is not limited to this example. The motor 314 may have motor windings of delta (Δ) connection, or motor windings designed to be switchable between Y connection and Δ connection.

In addition, the configuration and the arrangement of components in the power converting apparatus 1 illustrated in FIG. 1 are provided merely by way of example. The configuration and the arrangement of components are not limited to those of the example illustrated in FIG. 1. For example, the reactor 120 may be disposed downstream of the rectifier unit 130. Moreover, the power converting apparatus 1 may include a booster unit or incorporate a function of booster unit in the rectifier unit 130. The current detection units 501 and 502, the voltage detection unit 503, and the current detection units 313a and 313b may each be referred to hereinafter simply as “detection unit”. In addition, the current values detected by the current detection units 501 and 502, the voltage value detected by the voltage detection unit 503, and the current values detected by the current detection units 313a and 313b may each be referred to hereinafter simply as “detection value”.

The control unit 400 obtains the detection value of the first current I1 detected by the current detection unit 501, the detection value of the second current I2 detected by the current detection unit 502, and the detection value of the DC bus voltage V_{dc} detected by the voltage detection unit 503. The control unit 400 also obtains the detection values of the motor currents detected by the current detection units 313a and 313b. The control unit 400 controls operation of the inverter 310, specifically, ON and OFF states of the switching elements 311a to 311f included in the inverter 310, using the detection value(s) detected by the corresponding one(s) of the detection units. The control unit 400 also controls operation of the inverter 310 to cause AC power including a pulsation dependent on the pulsation of the power flowing from the rectifier unit 130 into the capacitor 210 of the smoothing unit 200 to be output from the inverter 310 to the compressor 315. The pulsation dependent on the pulsation of the power flowing into the capacitor 210 of the smoothing unit 200 is, for example, a pulsation that fluctuates depending on a factor such as the frequency of the pulsation of the power flowing into the capacitor 210 of the smoothing unit 200. Through such control, the control unit 400 reduces a third current I3, which flows to the capacitor 210 of the smoothing unit 200. The third current I3 is a charge-discharge current of the capacitor 210 of the smoothing unit 200. The control unit 400 provides control to cause one of the speed, the voltage, and the current of the motor 314 to satisfy a desired condition. Note that the control unit 400 does not need to use all the detection values obtained from the respective detection units, but can provide control using part of the detection values.

When the motor 314 is used for driving the compressor 315, and the compressor 315 is a hermetic compressor, installation of a position sensor for detecting the rotor position, on the motor 314, is often difficult in terms of both structure and cost. Accordingly, the control unit 400 controls the motor 314 without using a position sensor. There are two types of methods for position sensorless control method for the motor 314, which are constant primary magnetic flux control and sensorless vector control. The first embodiment is described primarily on the basis of sensorless vector control by way of example. Note that the control method described below is also applicable to constant primary magnetic flux control with a minor modification.

A particular operation in the control unit 400 of the first embodiment will next be described. First, the first current I1 flowing from the rectifier unit 130 basically has a characteristic including a component that is 2n times (where n is an integer greater than or equal to 1) the power supply frequency although affected by factors such as the power supply phase of the commercial power supply 110 and characteristics of elements disposed upstream and downstream of the rectifier unit 130. In addition, in the capacitor 210, a high value of the third current I3, which is the charge-discharge current, accelerates aging degradation of the capacitor 210. In particular, when an electrolytic capacitor is used as the capacitor 210, aging degradation is more accelerated. The control unit 400 thus controls the inverter 310 to match the first current I1 with the second current I2 to perform control to cause the third current I3 to approach zero. This reduces degradation of the capacitor 210. Note, however, that a ripple component caused by pulse width modulation (PWM) is superimposed on the second current I2. This requires the control unit 400 to control the inverter 310 taking into account the ripple component. The control unit 400 monitors the power state of the smoothing unit 200, i.e., the capacitor 210, and provides an appropriate pulsation to the motor 314 to reduce the third current I3.

In the power converting apparatus 1, the current detection unit 501 detects the current value of the first current I1 flowing to the capacitor 210, and outputs the detection value to the control unit 400. The control unit 400 controls the inverter 310 to match, with the first current I1, the value obtained by removing the PWM ripple from the second current I2 flowing from the capacitor 210 to the inverter 310, thus to add a pulsation to the power that is to be output to the motor 314. The control unit 400 can reduce the third current I3 of the capacitor 210 by causing the second current I2 to pulsate appropriately. Pulsation compensation performed by this control operation is called “power-supply pulsation compensation”.

Note that the first current I1 flowing to the capacitor 210 includes a component that is 2n times the power supply frequency as described above, meaning that the second current I2 and the q-axis current of the motor 314 also include the component that is 2n times the power supply frequency. This requires the power converting apparatus 1 to cause the second current I2 and the q-axis current of the motor 314 to pulsate appropriately.

In addition, it is known that when the compressor 315 is used, for example, in an air conditioner, a certain type of the load of the compressor 315 includes a mechanism that generates a periodic rotational fluctuation even when the load of the compressor 315 is almost constant, that is, even when the root-mean-square value of the second current I2 is constant. Thus, driving a compressor load including such mechanism causes the load torque to periodically fluctuate. In this case, driving the compressor 315 with a constant output current from the inverter 310, i.e., with a constant torque output, causes a speed fluctuation due to a torque difference. The speed fluctuation has a characteristic of being significant in a low-speed range and decreasing as the operating point moves toward a high-speed range. In addition, the speed fluctuation component is transferred externally to thereby be observed as vibration externally. This requires a measure such as additional installation of an anti-vibration component to be taken. To this end, a method is often used in which torque dependent on the load torque fluctuation is provided from the inverter 310 to the compressor 315 by causing a current equivalent to the pulsating torque component, i.e., the pulsating current component, to flow to the compressor 315 in addition to the constant current output from the inverter 310, i.e., in addition to the constant torque output current component. This enables a torque difference between the output torque of the inverter 310 and the load torque to approach zero. This enables reduction in the speed fluctuation of the motor 314 included in the compressor 315, and reduction in vibration of the compressor 315. Pulsation compensation performed by this control operation is called “load pulsation compensation”.

As described above, in the first embodiment, the control unit 400 performs power-supply pulsation compensation for compensating power-supply pulsation and load pulsation compensation for compensating load pulsation. These pulsation compensation operations can be performed based on the detection value of the first current I1, the second current I2, or the DC bus voltage V_{dc}, which are information for understanding the power state of the capacitor 210. Note that the third current I3 can be obtained based on a difference between the first current I1 and the second current I2. The third current I3 may thus be used as information for understanding the power state of the capacitor 210.

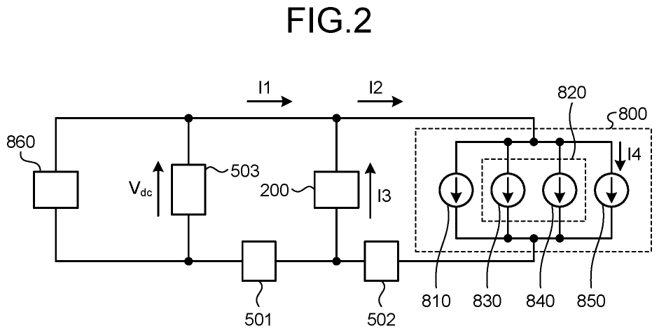

FIG. 2 is a block diagram illustrating the power converting apparatus 1 according to the first embodiment, focusing the functionality thereof. In FIG. 2, configuration parts that are the same as or equivalent to components illustrated in FIG. 1 are designated by like reference characters.

FIG. 2 illustrates, as circuit elements, a power supply unit 860, the smoothing unit 200, the current detection units 501 and 502, the voltage detection unit 503, and a load unit 800. The power supply unit 860 is a conceptional unit including the commercial power supply 110 and the rectifier unit 130. The load unit 800 is a conceptional unit including the inverter 310, the compressor 315 including the motor 314, and the control unit 400. The load unit 800 includes, as components thereof, a constant current load unit 810, a pulsation compensation unit 820, and an adjustment unit 850. In addition, the pulsation compensation unit 820 includes, as components thereof, a load pulsation compensation unit 830 and a power-supply pulsation compensation unit 840. Note that when current is used as the physical quantity for describing the load, description is suitably provided using current sources. FIG. 2 accordingly illustrates the components as current sources.

As described above, a certain type of the compressor 315 includes a mechanism that generates a periodic rotational fluctuation. When such compressor motor load is to be driven, the load pulsation compensation described above is performed. In contrast to constant current control, in which a constant current is output by the inverter 310, the load pulsation compensation is performed to cause a pulsation current component to flow to the load in addition to the above constant current, where this pulsation current component corresponds to load pulsation compensation torque. The element causing this pulsation current component to flow can be depicted by adding the load pulsation compensation unit 830 in parallel with the constant current load unit 810 as illustrated in FIG. 2. That is, the load pulsation compensation unit 830 is a component for performing load pulsation compensation. A configuration and an operation of the load pulsation compensation unit 830 will be described later in detail.

Similarly, when the power-supply pulsation compensation described above is performed, a pulsation current component provided by the power-supply pulsation compensation is caused to flow to the load. The element causing this pulsation current component to flow can be depicted by further adding the power-supply pulsation compensation unit 840 in parallel as illustrated in FIG. 2. That is, the power-supply pulsation compensation unit 840 is a component for performing power-supply pulsation compensation. A configuration and an operation of the power-supply pulsation compensation unit 840 will be described later in detail.

In the first embodiment, the adjustment unit 850 is further provided to operate the apparatus with high efficiency. The adjustment unit 850 is a component for adjusting the degree of at least one pulsation compensation of the load pulsation compensation and the power-supply pulsation compensation. A configuration and an operation of the adjustment unit 850 will be described later in detail.

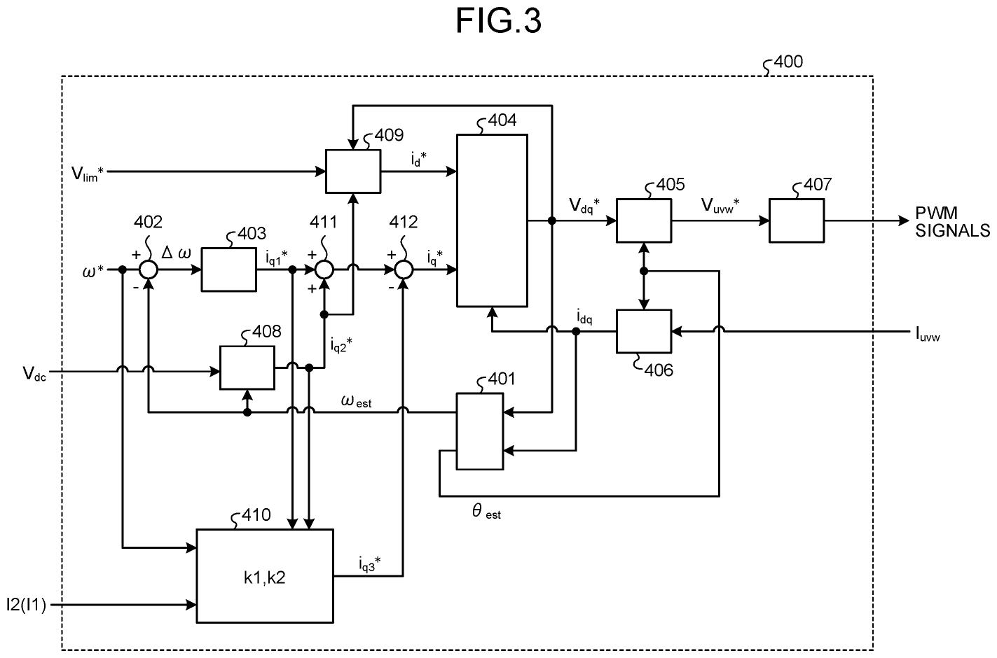

A configuration of the control unit 400, which provides the functionality of the load unit 800 described above, will next be described. FIG. 3 is a block diagram illustrating an example configuration of the control unit 400 included in the power converting apparatus 1 according to the first embodiment. The control unit 400 includes a rotor position estimation unit 401, a subtraction unit 402, a speed control unit 403, a current control unit 404, coordinate transformation units 405 and 406, a PWM signal generation unit 407, a q-axis current pulsation calculation unit 408, a flux-weakening control unit 409, a current-adjusting calculation unit 410, an addition unit 411, and a subtraction unit 412.

The rotor position estimation unit 401 estimates an estimated phase angle θₑₛₜ and an estimated speed ωₑₛₜ using a dq-axis voltage command vector V_{dq}* and a dq-axis current vector i_{dq} for driving the motor 314, where the estimated phase angle θₑₛₜ is the direction, with respect to dq axes, of the rotor magnetic pole, and the estimated speed ωₑₛₜ is the rotor speed, of a rotor (not illustrated) included in the motor 314.

The subtraction unit 402 and the speed control unit 403 are components that provide the functionality of the load pulsation compensation unit 830 of FIG. 2. The subtraction unit 402 calculates a speed deviation Δω, which is a deviation between a speed command ω* and the estimated speed ωₑₛₜ, and outputs the speed deviation Δω to the speed control unit 403. The speed command ω* is a command value for the rotational speed of the motor 314. The speed control unit 403 automatically adjusts a q-axis current pulsation command i_{q1}* to bring the speed deviation Δω to zero, that is, to match the estimated speed ωₑₛₜ with the speed command ω*.

When the power converting apparatus 1 is used in an apparatus such as an air conditioner as a refrigeration cycle-incorporating device, the speed command ω* is based on, for example, a temperature detected by a temperature sensor (not illustrated), information representing a setting temperature commanded from a remote controller (not illustrated) serving as an operation unit, operation mode selection information, information of commanding start of operation and stop of operation, and/or the like. Examples of the operation mode include heating, cooling, and dehumidification.

Performing control to bring the speed deviation Δω to zero results in decrease in speed fluctuation of the motor 314. A decrease in the speed fluctuation of the motor 314 causes decrease in load pulsation. Thus, the control to automatically adjust the q-axis current pulsation command i_{q1}* using the speed deviation Δω corresponds to the load pulsation compensation described above.

The current control unit 404 automatically adjusts a dq-axis voltage command vector V_{dq}* to cause the dq-axis current vector i_{dq} to follow a d-axis current command i_{d}* and a q-axis current command i_{q}*.

The coordinate transformation unit 405 performs coordinate transformation, based on the estimated phase angle θₑₛₜ, to convert the dq-axis voltage command vector V_{dq}* represented by dq coordinates into a voltage command V_{uvw}* represented by an AC amount.

The coordinate transformation unit 406 performs coordinate transformation, based on the estimated phase angle θₑₛₜ, to convert a current I_{uvw} flowing to the motor 314 represented by an AC amount into the dq-axis current vector i_{dq} represented by dq coordinates. As described above, the control unit 400 can obtain the current I_{uvw} flowing to the motor 314 from current values of two phases detected by the current detection units 313a and 313b and a current value of the remaining one phase calculated using the current values of the two phases, of the current values of the three phases output from the inverter 310.

The PWM signal generation unit 407 generates PWM signals based on the voltage command V_{uvw}* obtained by coordinate transformation performed by the coordinate transformation unit 405. The control unit 400 outputs the PWM signals generated by the PWM signal generation unit 407 to the switching elements 311a to 311f of the inverter 310 to thereby apply a voltage to the motor 314.

The q-axis current pulsation calculation unit 408 is a component that provides the functionality of the power-supply pulsation compensation unit 840 of FIG. 2. The q-axis current pulsation calculation unit 408 calculates a q-axis current pulsation command i_{q2}* based on the detection value of the DC bus voltage V_{dc} detected by the voltage detection unit 503 and on the estimated speed ωₑₛₜ. The q-axis current pulsation command i_{q2}* is generated upon performing control of the power-supply pulsation compensation. The q-axis current pulsation command i_{q2}* is a command value for the q-axis current for reducing the third current I3.

The flux-weakening control unit 409 automatically adjusts the d-axis current command i_{d}* to cause the absolute value of the dq-axis voltage command vector V_{dq}* to fall within a limitation value of the voltage limit value Vₗᵢₘ*. In addition, in the first embodiment, the flux-weakening control unit 409 performs flux-weakening control taking into account the q-axis current pulsation command i_{q2}* calculated by the q-axis current pulsation calculation unit 408. There are two types of methods for flux-weakening control in general, which are a method to calculate the d-axis current command i_{d}* using a voltage limit ellipse equation, and a method to calculate the d-axis current command i_{d}* to bring the deviation between the voltage limit value Vₗᵢₘ* and the absolute value of the dq-axis voltage command vector V_{dq}* to zero. Any one of these methods may be used.

The current-adjusting calculation unit 410 is a component that provides the functionality of the adjustment unit 850 of FIG. 2. The current-adjusting calculation unit 410 receives the speed command ω*, the q-axis current pulsation command i_{q1}*, the q-axis current pulsation command i_{q2}*, and the detection value of the second current I2. The current-adjusting calculation unit 410 calculates a first adjustment factor k1 based on the speed command ω*. Alternatively, the current-adjusting calculation unit 410 calculates the first adjustment factor k1 based on the speed command ω* and on the detection value of the second current I2. The current-adjusting calculation unit 410 also calculates a second adjustment factor k2 based on the detection value of the second current I2. The first adjustment factor k1 is a factor for adjustment of the degree of the load pulsation compensation. The second adjustment factor k2 is a factor for adjustment of the degree of the power-supply pulsation compensation. The first and second adjustment factors k1 and k2 are each a real number value ranging from 0 to 1 inclusive. The current-adjusting calculation unit 410 further calculates a q-axis current pulsation adjustment command i_{q3}* using the first and second adjustment factors k1 and k2 calculated. The q-axis current pulsation command i_{q2}* is a command value for the q-axis current for adjusting the degree of at least one pulsation compensation of the load pulsation compensation and the power-supply pulsation compensation. The values of the q-axis current pulsation command i_{q1}* and of the q-axis current pulsation command i_{q2}* are adjusted by the first and second adjustment factors k1 and k2, and the values resulting from the adjustment are output to the subtraction unit 412 as the q-axis current pulsation adjustment command i_{q3}*.

Note that although the current-adjusting calculation unit 410 of FIG. 3 receives the detection value of the second current I2 as an input signal, the current-adjusting calculation unit 410 may receive the detection value of the first current I1 as an input signal instead of the second current I2.

The addition unit 411 adds together the q-axis current pulsation command i_{q1}* output from the speed control unit 403 and the q-axis current pulsation command i_{q2}* calculated by the q-axis current pulsation calculation unit 408, and outputs the calculated sum to the subtraction unit 412.

The subtraction unit 412 then subtracts the q-axis current pulsation adjustment command i_{q3}* calculated by the current-adjusting calculation unit 410 from the sum output from the addition unit 411, of the q-axis current pulsation command i_{q1}* and the q-axis current pulsation command i_{q2}*, and outputs the calculated difference, i.e., the q-axis current command i_{q}*, to the current control unit 404 as a torque current command.

Essential points of the operation in the power converting apparatus 1 according to the first embodiment will next be described. First, consideration is given to the second current I2 flowing into the load unit 800 of FIG. 2. This second current I2 can be expressed by Equation (1) below.

$$I 2 = A + B \cdot cos ( 2 π f 1 \cdot t ) + C \cdot cos ( 2 π f 2 \cdot t ) \qquad ( 1 )$$

In Equation (1) above, “A” in the first term represents the constant current in the constant current load unit 810, the second term represents the load pulsation current in the load pulsation compensation unit 830, and the third term represents the power-supply pulsation current in the power-supply pulsation compensation unit 840. In addition, “f1” represents the mechanical angular frequency of the periodic load pulsation, and “f2” represents the power-supply pulsation frequency in the smoothing unit 200.

For example, when the commercial power supply 110 in the power supply unit 860 is a single-phase power supply, a voltage ripple having a second-order frequency component of the power supply frequency fs occurs in a high proportion in the smoothing unit 200. Relationship of f2=2·fs can thus be used. Alternatively, when the commercial power supply 110 is a three-phase power supply, a voltage ripple having a sixth-order frequency component of the power supply frequency fs occurs in a high proportion in the smoothing unit 200. Relationship of f2=6·fs can thus be used.

It is assumed here that the capacitor 210 in the smoothing unit 200 has a relatively small capacitance generally ranging from several hundred microfarads to several thousand microfarads, and that a voltage ripple of several tens of volts or higher occurs. Note that when the capacitor 210 has a capacitance sufficiently large for load power, the third term of Equation (1) above is negligible. That is, when the voltage ripple has a sufficiently low voltage value, the power-supply pulsation compensation unit 840 may be omitted.

Next, consideration is given to a mechanical mechanism of the compressor 315. For example, when the compressor 315 is a single-type rotary compressor, i.e., a single-cylinder rotary compressor, a load pulsation having a first-order frequency component of the mechanical angular frequency fm is included in a high proportion due to the mechanical mechanism thereof. The compensation component for the load pulsation is therefore the first-order frequency component of mechanical angular frequency fm. Relationship of f1=fm can thus be used in the second term of Equation (1) above.

Alternatively, when the compressor 315 is, for example, a twin-type rotary compressor, i.e., a dual-cylinder rotary compressor, a load pulsation having a second-order frequency component of the mechanical angular frequency fm is included in a high proportion due to the mechanical mechanism thereof. Relationship of f1=2·fm can thus be used in the second term of Equation (1) above.

Further alternatively, when the compressor 315 is a scroll compressor, the load pulsation observed in a rotary compressor has a small magnitude in many types of scroll compressors. Accordingly, the second term of Equation (1) above is negligible depending on the type of the scroll compressor. That is, the load pulsation compensation unit 830 may be omitted depending on the type of the periodic load on the load unit 800.

In addition, the equation of motion of the rotating system can be expressed by Equation (2) below.

$$Δ ω = \int \{ ( T m - Tl ) / J \} dt \qquad ( 2 )$$

In Equation (2) above, “Δω” represents the speed deviation, “Tm” represents the output torque, “Tl” represents the load torque, and “J” represents the inertia. As shown by Equation (2) above, a smaller value of the output torque Tm relative to the load torque Tl results in a smaller rotational speed of the motor 314 relative to the command value. On the contrary, a larger value of the output torque Tm relative to the load torque Tl results in a higher rotational speed of the motor 314 relative to the command value.

Note that it is assumed by Equation (2) above that the inertia J has a relatively large value relative to the load torque Tl, thereby enabling stable speed control. Meanwhile, the speed deviation Δω may continue to remain persistently depending on the operating condition of the load or the magnitude of the inertia J.

In addition, in each of the load pulsation compensation and the power-supply pulsation compensation, a component of an order other than the compensation order remains. Accordingly, a compensation term other than the terms of the load pulsation compensation and of the power-supply pulsation compensation may be added in Equation (1) above as needed.

In any case, use of a concept of performing pulsation compensation in the load unit 800 enables reduction in various pulsations including the load pulsation compensation and the power-supply pulsation compensation. Meanwhile, as also described in the section of “Problem to be solved by the Invention”, reduction in various pulsations causes an increase in the root-mean-square values of the motor current and of the inverter current, thereby causing an increase in losses in the semiconductor devices and in the motor windings. This leads to a decrease in efficiency of the apparatus. This requires adjustment of operation depending on the operating condition of the load while considering the losses in the semiconductor devices and in the motor windings. To solve this issue, the adjustment unit 850 is provided as illustrated in FIG. 2.

As illustrated in FIG. 2, an adjustment current in the adjustment unit 850 is denoted by “I4”. This adjustment current I4 can be expressed by Equation (3) below using the first and second adjustment factors k1 and k2 described above.

$$I 4 = - k 1 \cdot B \cdot cos ( 2 π f 1 \cdot t ) - k 2 \cdot C \cdot cos ( 2 π f 2 \cdot t ) \qquad ( 3 )$$

In this respect, the second current I2 in the case where the adjustment unit 850 is included is a resultant current yielded from a combination of Equations (1) and (3) above. The second current I2 in the case where the adjustment unit 850 is included can be expressed by Equation (4) below.

$$I 2 = A + ( 1 - k 1 ) \cdot B \cdot cos ( 2 π f 1 \cdot t ) + ( 1 - k 2 ) \cdot C \cdot cos ( 2 π f 2 \cdot t ) \qquad ( 4 )$$

As is understood from Equation (4) above, setting the first and second adjustment factors k1 and k2 to values other than 0 enables reduction of the second current I2. Thus, causing the adjustment current I4 expressed by Equation (3) above to flow in the adjustment unit 850 enables the pulsation current to be adjusted taking into account the losses in the semiconductor devices and in the motor windings, with less impact on the pulsation compensation operation performed in the pulsation compensation unit 820 using a relatively simple technique. This enables high-efficiency operation of the apparatus and stable operation of the apparatus.

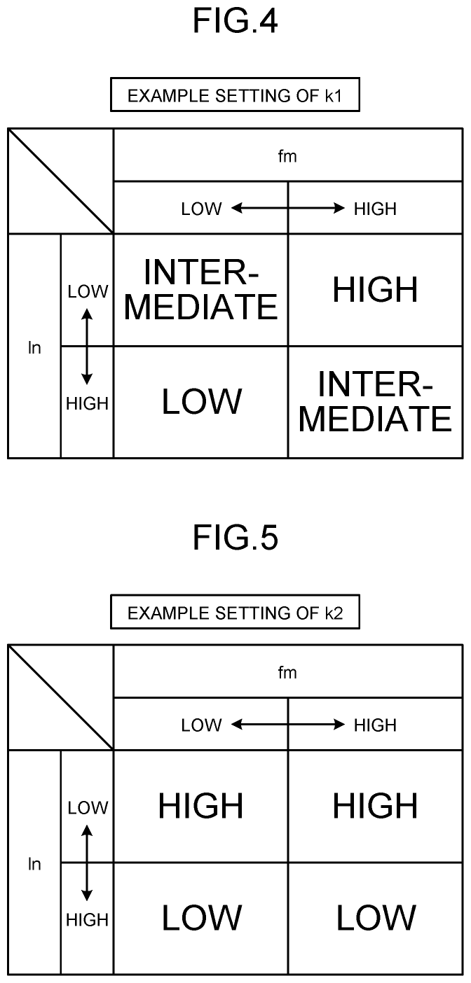

Example settings of the first and second adjustment factors k1 and k2 will next be described. FIG. 4 is a diagram for describing example settings of the first adjustment factor k1 for use in the current-adjusting calculation unit 410 according to the first embodiment. Setting the first adjustment factor k1 at a low value means a reduction of the adjustment current I4 for the load pulsation compensation, while setting the first adjustment factor k1 at a high value means active conduction of the adjustment current I4 for the load pulsation compensation.

The first adjustment factor k1 described above can be expressed as Equation (5) below as a function of a current In and the mechanical angular frequency fm.

$$k 1 = f ( I n , fm ) \qquad ( 5 )$$

In this equation, the suffix n of the current In is n=1 or 2, where n=1 means the case of the first current I1, and n=2 means the case of the second current I2.

FIG. 4 illustrates a relationship between the current In and the mechanical angular frequency fm in the case of setting the first adjustment factor k1. Information of the mechanical angular frequency fm can be obtained from the speed command ω*, which is an input signal to the current-adjusting calculation unit 410. When the mechanical angular frequency fm is low, and the current In is high, the load pulsation has a large magnitude. Thus, the first adjustment factor k1 is set at a low value to reduce the load pulsation. This causes the load pulsation compensation to be actively performed, thereby causing the load pulsation to be reduced.

Alternatively, when the mechanical angular frequency fm is low, and the current In is low, the load pulsation has an intermediate magnitude. Similarly, when the mechanical angular frequency fm is high, and the current In is high, the load pulsation has also an intermediate magnitude. Thus, the first adjustment factor k1 is also set at an intermediate value in these cases.

Still alternatively, when the mechanical angular frequency fm is high, and the current In is low, the load pulsation has a small magnitude. Thus, the first adjustment factor k1 is set at a high value to appropriately reduce the current for the load pulsation compensation. This enables reduction in the losses in the semiconductor devices and in the motor windings while reducing the load pulsation.

In addition, the second adjustment factor k2 described above can be expressed as Equation (6) below as a function of the current In.

$$k 2 = f ( I n ) \qquad ( 6 )$$

The suffix n of the current In means the same as that in the Equation (5) above. As shown by Equation (6) above, the second adjustment factor k2 depends very little on the mechanical angular frequency fm, but depends on the current In. This relationship is illustrated in FIG. 5. FIG. 5 is a diagram for describing example settings of the second adjustment factor k2 for use in the current-adjusting calculation unit 410 according to the first embodiment. Setting the second adjustment factor k2 at a low value means a reduction of the adjustment current I4 for the power-supply pulsation compensation, while setting the second adjustment factor k2 at a high value means active conduction of the adjustment current I4 for the power-supply pulsation compensation.

When the current In is high, the power-supply pulsation has a large magnitude. Thus, the second adjustment factor k2 is set at a low value to reduce the power-supply pulsation. This causes the power-supply pulsation compensation to be actively performed, thereby causing the power-supply pulsation to be reduced. Alternatively, when the current In is low, the power-supply pulsation has a small magnitude. Thus, the second adjustment factor k2 is set at a high value to appropriately reduce the current for the power-supply pulsation compensation. This enables reduction in the losses in the semiconductor devices and in the motor windings while reducing the power-supply pulsation.

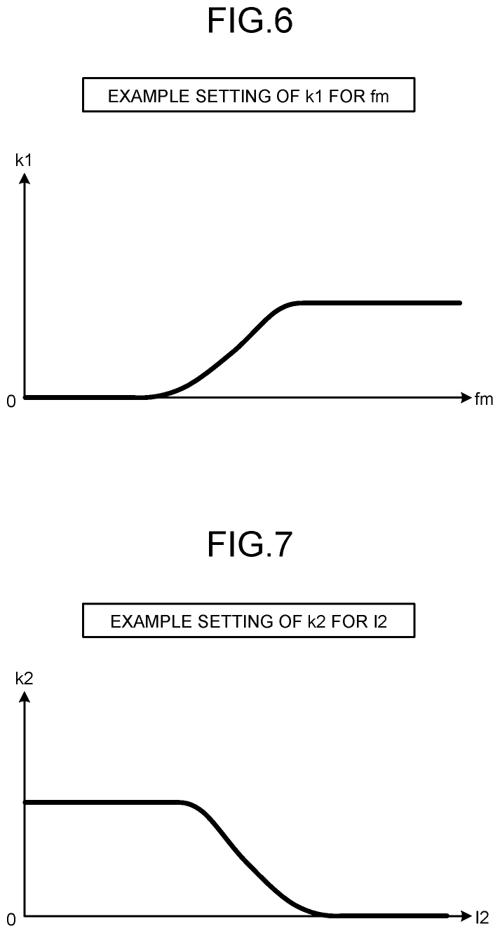

FIG. 6 is a diagram for describing an example setting of the first adjustment factor k1 with respect to the mechanical angular frequency fm for use in the current-adjusting calculation unit 410 according to the first embodiment. The horizontal axis of FIG. 6 represents the mechanical angular frequency fm. The vertical axis of FIG. 6 represents the first adjustment factor k1. A low value of the mechanical angular frequency fm means a slow rotational speed of the motor 314, while a high value of the mechanical angular frequency fm means a high rotational speed of the motor 314. In addition, FIG. 6 illustrates an example characteristic when the second current I2 is relatively high.

When the second current I2 is relatively high, a low value of the mechanical angular frequency fm results in a large load pulsation. Accordingly, when the mechanical angular frequency fm is low, the first adjustment factor k1 is set at a low value to reduce the load pulsation. The load pulsation compensation is thus actively performed to cause the load pulsation to be reduced. Alternatively, when the second current I2 is relatively high, a high value of the mechanical angular frequency fm results in a small load pulsation. Accordingly, when the mechanical angular frequency fm is high, the first adjustment factor k1 is set at an intermediate value to appropriately reduce the current for the load pulsation compensation. Note that storing data for performing such control in a memory or in a processing circuitry described later in a form of table will enable the adjustment current I4 for the load pulsation compensation to be changed depending on the operating condition.

As described above, the control unit 400 sets the first adjustment factor k1 at a low value when the rotational speed of the motor 314 is low, and sets the first adjustment factor k1 at a high value when the rotational speed of the motor 314 is high. This causes the adjustment current I4 for adjusting the degree of the load pulsation compensation to be lower when the rotational speed is low than when the rotational speed is high. This enables the first adjustment factor k1 to be set at an appropriate value, and the compensation current relating to the load pulsation to be adjusted to an appropriate level, thereby enabling reduction in excessive losses in the semiconductor devices and in the motor windings.

FIG. 7 is a diagram for describing an example setting of the second adjustment factor k2 with respect to the second current I2 for use in the current-adjusting calculation unit 410 according to the first embodiment. The horizontal axis of FIG. 7 represents the second current I2. The vertical axis of FIG. 7 represents the second adjustment factor k2. In addition, FIG. 7 illustrates an example characteristic when the mechanical angular frequency fm is relatively high.

When the mechanical angular frequency fm is relatively high, a high value of the second current I2 results in a large power-supply pulsation. Accordingly, when the second current I2 is high, the second adjustment factor k2 is set at a low value to reduce the power-supply pulsation. The power-supply pulsation compensation is thus actively performed to cause the power-supply pulsation to be reduced. Alternatively, when the mechanical angular frequency fm is relatively high, a low value of the second current I2 results in a small power-supply pulsation. Accordingly, when the second current I2 is low, the second adjustment factor k2 is set at a high value to appropriately reduce the current for the power-supply pulsation compensation. Note that storing data for performing such control in a memory or in a processing circuitry described later in a form of table will enable the adjustment current I4 for the power-supply pulsation compensation to be changed depending on the operating condition.

Note that when the mechanical angular frequency fm is relatively high, a low value of the second current I2 means that the motor 314 is subjected to a light load, while, on the contrary, a high value of the second current I2 means that the motor 314 is subjected to a heavy load. Accordingly, the control unit 400 sets the second adjustment factor k2 at a high value when the motor 314 is subjected to a light load, and sets the second adjustment factor k2 at a low value when the motor 314 is subjected to a heavy load. This causes the adjustment current I4 for adjusting the degree of the power-supply pulsation compensation to be lower when the motor 314 is subjected to a heavy load than when the motor 314 is subjected to a light load. This enables the second adjustment factor k2 to be set at an appropriate value, and the compensation current relating to the power-supply pulsation to be adjusted to an appropriate level, thereby enabling reduction in excessive losses in the semiconductor devices and in the motor windings.

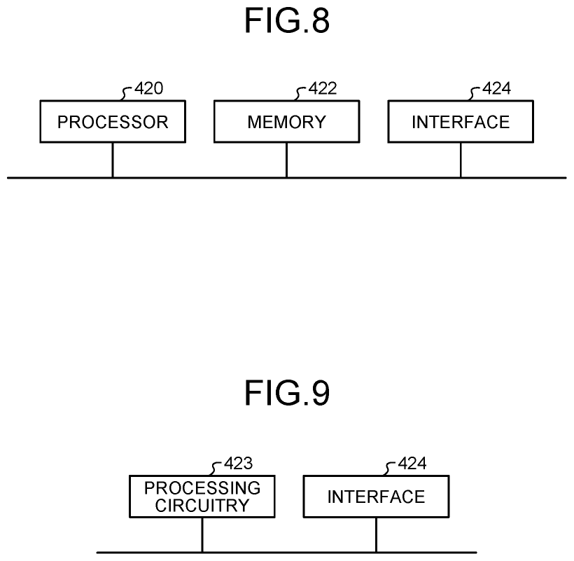

A hardware configuration for implementing the functionality of the control unit 400 according to the first embodiment will next be described with reference to the drawings of FIGS. 8 and 9. FIG. 8 is a block diagram illustrating an example of hardware configuration for implementing the functionality of the control unit 400 according to the first embodiment. FIG. 9 is a block diagram illustrating another example of hardware configuration for implementing the functionality of the control unit 400 according to the first embodiment.

Part or all of the functionality of the control unit 400 can be implemented using a configuration including, as illustrated in FIG. 8, a processor 420, which performs computation; a memory 422, which stores a program to be read by the processor 420; and an interface 424, which inputs and outputs signals.

The processor 420 is an example of computing means. The processor 420 may be computing means called microprocessor, microcomputer, central processing unit (CPU), or digital signal processor (DSP). In addition, the memory 422 can be, by way of example, a non-volatile or volatile semiconductor memory such as a random access memory (RAM), a read-only memory (ROM), a flash memory, an erasable programmable ROM (EPROM), or an electrically erasable programmable ROM (EEPROM) (registered trademark); a magnetic disk, a flexible disk, an optical disk, a compact disc, a MiniDisc, or a digital versatile disc (DVD).

The memory 422 stores a program for performing the functionality of the control unit 400. The processor 420 provides and receives necessary information via the interface 424. The processor 420 executes a program stored in the memory 422. The processor 420 refers to data stored in the memory 422. Through these operations, the processor 420 can perform the foregoing processes. Results of computation performed by the processor 420 can be stored in the memory 422.

In addition, the processor 420 and the memory 422 illustrated in FIG. 8 may be replaced with a processing circuitry 423 of FIG. 9. The processing circuitry 423 corresponds to a single circuit, a set of multiple circuits, an application specific integrated circuit (ASIC), a field-programmable gate array (FPGA), or a combination thereof. Information input to the processing circuitry 423 and information to be output from the processing circuitry 423 can be obtained via the interface 424.

Note that the operations in the control unit 400 may be performed in such a manner that part of the operations are performed in the processing circuitry 423, and operations not to be performed in the processing circuitry 423 are performed using the processor 420 and the memory 422.

As described above, according to the power converting apparatus according to the first embodiment, the control unit performs, by controlling the inverter, load pulsation compensation to compensate a load pulsation in the load unit including the inverter and the device and power-supply pulsation compensation to compensate a power-supply pulsation in the load unit, and adjusts the degree of at least one of the load pulsation compensation and the power-supply pulsation compensation on the basis of the detection value of a corresponding one of the detection units. This enables the current for at least one of the load pulsation compensation and the power-supply pulsation compensation to be appropriately adjusted, thereby enabling reduction in the losses in the semiconductor devices and in the motor windings. This enables increase in the size of the apparatus to be avoided, and moreover, the apparatus to be operated with high efficiency while reducing degradation of the capacitor for smoothing.

When the detection value of the corresponding one of the detection units is that of the first current flowing from the rectifier unit or the second current flowing into the inverter, the control unit can adjust the degree of the power-supply pulsation compensation on the basis of the detection value of the first current or the second current. The control unit can also adjust the degree of the load pulsation on the basis of the speed command that is the command value for the rotational speed of the motor. The control unit can also adjust the degree of the power-supply pulsation compensation on the basis of the speed command and the detection value of at least one of the first current and the second current.

Note that the current for adjustment of the degree of the load pulsation compensation can be set at a lower value when the rotational speed of the motor is low than when the rotational speed of the motor is high. Such setting enables the compensation current relating to the load pulsation to be adjusted to an appropriate level, thereby enabling reduction in excessive losses in the semiconductor devices and in the motor windings.

In addition, the current for adjustment of the degree of the power-supply pulsation compensation can be set at a lower value when the motor is subjected to a heavy load than when the motor is subjected to a light load. Such setting enables the compensation current relating to the power-supply pulsation to be adjusted to an appropriate level, thereby enabling reduction in excessive losses in the semiconductor devices and in the motor windings.

Moreover, a configuration can be provided in which the current for adjustment of the degree of the load pulsation compensation and the degree of the power-supply pulsation compensation is superimposed on the torque current command. Such configuration can reduce an impact on an existing control block that performs the load pulsation compensation and the power-supply pulsation compensation.

Note that in an application in which the apparatus primarily operates under an operating condition of a light load, use of a band-stop filter upstream or downstream of the speed controller is preferred. Such configuration enables operation to be performed with higher efficiency.

### Second Embodiment

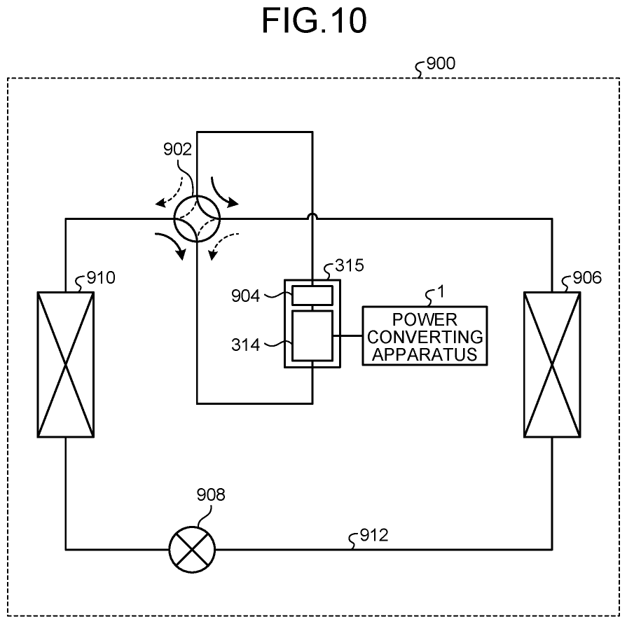

FIG. 10 is a diagram illustrating an example configuration of a refrigeration cycle-incorporating device 900 according to a second embodiment. The refrigeration cycle-incorporating device 900 according to the second embodiment includes the power converting apparatus 1 described in the first embodiment. The refrigeration cycle-incorporating device 900 according to the second embodiment is applicable to products including a refrigeration cycle, such as an air conditioner, a refrigerator, a freezer, and a heat pump water heater. Note that, in FIG. 10, components having functionality similar to the functionality in the first embodiment are designated by the same reference characters as the reference characters of the first embodiment.

The refrigeration cycle-incorporating device 900 includes the compressor 315 incorporating the motor 314 of the first embodiment, a four-way valve 902, an indoor heat exchanger 906, an expansion valve 908, and an outdoor heat exchanger 910, which are attached to each other with a refrigerant pipe 912 disposed therebetween.

The compressor 315 includes therein a compression mechanism 904 for compressing a refrigerant, and the motor 314 for operating the compression mechanism 904.

The refrigeration cycle-incorporating device 900 is capable of performing heating operation or cooling operation through switching of the four-way valve 902. The compression mechanism 904 is driven by the motor 314, which operates under variable speed control.

In heating operation, the refrigerant is pressurized and discharged by the compression mechanism 904, flows through the four-way valve 902, the indoor heat exchanger 906, the expansion valve 908, the outdoor heat exchanger 910, and the four-way valve 902, and returns back to the compression mechanism 904 as indicated by the solid line arrows.

In cooling operation, the refrigerant is pressurized and discharged by the compression mechanism 904, flows through the four-way valve 902, the outdoor heat exchanger 910, the expansion valve 908, the indoor heat exchanger 906, and the four-way valve 902, and returns back to the compression mechanism 904 as indicated by the broken line arrows.

In heating operation, the indoor heat exchanger 906 acts as a condenser to release heat, and the outdoor heat exchanger 910 acts as an evaporator to absorb heat. In cooling operation, the outdoor heat exchanger 910 acts as a condenser to release heat, and the indoor heat exchanger 906 acts as an evaporator to absorb heat. The expansion valve 908 depressurizes and expands the refrigerant.

The configurations described in the foregoing embodiments are merely examples. These configurations may be combined with another known technology, and moreover, part of such configurations may be omitted and/or modified without departing from the spirit thereof.

1. A power converting apparatus comprising:
a rectifier unit rectifying a supply voltage applied from an alternating-current power supply;
a capacitor connected to an output end of the rectifier unit;
an inverter connected across the capacitor, the inverter converting direct-current power output from the capacitor into alternating-current power and outputting the alternating-current power to a device comprising a motor;
a detection unit detecting a power state of the capacitor; and
a control unit performing, by controlling the inverter, load pulsation compensation and power-supply pulsation compensation and adjusting a degree of at least one of the load pulsation compensation and the power-supply pulsation compensation on a basis of a detection value of the detection unit, the load pulsation compensation being performed to compensate a load pulsation in a load unit, the power-supply pulsation compensation being performed to compensate a power-supply pulsation in the load unit, the load unit comprising the inverter and the device.

2. The power converting apparatus according to claim 1, wherein
the detection unit detects a first current, the first current flowing from the rectifier unit, and
the control unit adjusts a degree of the power-supply pulsation compensation on a basis of a detection value of the first current.

3. The power converting apparatus according to claim 1, wherein
the detection unit detects a second current, the second current flowing into the inverter, and
the control unit adjusts a degree of the power-supply pulsation compensation on a basis of a detection value of the second current.

4. The power converting apparatus according to claim 1, wherein
the control unit adjusts a degree of the load pulsation on a basis of a speed command, the speed command being a command value for a rotational speed of the motor.

5. The power converting apparatus according to claim 4, wherein
the detection unit detects a first current, the first current flowing from the rectifier unit, and
the control unit adjusts a degree of the power-supply pulsation on a basis of the speed command and a detection value of the first current.

6. The power converting apparatus according to claim 5, wherein
the detection unit detects a second current, the second current flowing into the inverter, and
the control unit adjusts the degree of the power-supply pulsation on a basis of the speed command and a detection value of at least one of the first current and the second current.

7. The power converting apparatus according to claim 1, wherein
a current for adjustment of a degree of the load pulsation compensation is lower when a rotational speed of the motor is low than when the rotational speed of the motor is high.

8. The power converting apparatus according to claim 1, wherein
a current for adjustment of a degree of the power-supply pulsation compensation is lower when the motor is subjected to a heavy load than when the motor is subjected to a light load.

9. The power converting apparatus according to claim 1, wherein
a current for adjustment of a degree of the load pulsation compensation and a degree of the power-supply pulsation compensation is superimposed on a torque current command.

10. A motor drive unit comprising the power converting apparatus according to claim 1.

11. A refrigeration cycle-incorporating device comprising the power converting apparatus according to claim 1.
